(19) United States
(12) Patent Application Publication
(10) Pub. No.: US 2011/0318462 A1
(43) Pub. Date: Dec. 29, 2011

(54) Method and Apparatus For An Ice Cream Scooper

(76) Inventor: Jeffrey R. Uibel, Dripping Springs, TX (US)

(21) Appl. No.: 12/823,862

(22) Filed: Jun. 25, 2010

(51) Int. Cl. A23G 9/28; A23G 3/02; B29C 33/42

(52) U.S. Cl. 426/389; 425/278; 426/512

(57) ABSTRACT

A method and apparatus for an ice cream scooper. The apparatus includes at least four tines. The four tines are mechanically coupled to a retractable handle, and the retractable handle has a first position and a second position. The first position causes the four tines to be held in an open arrangement and the second position causes the four tines to be held in a closed arrangement. Each of the four tines is shaped to enable penetration of an ice cream surface when a downward force is applied to the retractable handle while the retractable handle is in the first position and the four tines are set in the open arrangement. Other embodiments are also disclosed.

### BACKGROUND OF THE INVENTION

1. Technical Field

The present invention relates in general to hand-held kitchen tools. In particular, the present invention relates to a method and apparatus for an ice cream scooper.

2. Description of the Related Art

Grasping tools such as a grapple or a robot end effector are known in the art. For example, ingressive robotic end effectors may include pins, needles or hackles which physically penetrate the surface of an object. However, kitchen tools of this nature are not common. Those of ordinary skill in the art may be familiar with kitchen tools such as tongs, scissors and even ice cream scoopers, but kitchen tools of this nature are not as complex as a grapple, much less as complex as an ingressive robotic end effector. Combining grapple and/or robotic end effector technology with development of hand-held kitchen tools would at most occur only in a specialized case of a physically challenged person.

Unless developing a kitchen tool for a physically challenged person, manufacturers would not be motivated to combine complex robotic-type technologies with the technologies for a general purpose kitchen tool such as an ice cream scooper. In other words, if developing a kitchen tool for use by the general public, manufacturers would not be motivated to combine complex technologies with simple kitchen tools. In addition, manufacturers would be far less motivated to combine complex technologies with simple kitchen tool technologies to produce an item that cannot even be used by many physically challenged people.

In the past, “high technology” ice cream scoopers have been made with levers to assist in extracting an ice cream scoop from an ice cream scooper. However, the fundamental design of the ice cream scooper has not radically changed over the years. A reason for this lack of change is that existing ice cream scoopers fulfill the need for scooping ice cream. Manufacturers have not felt a need to modify ice cream scooper design beyond possibly adding simple improvements such as a method for heating the scooper for easier penetration into solid ice cream. In addition, ice cream scooper manufactures sometimes suggest that users of their ice cream scoopers store the ice cream scooper in warm water when not in use.

In view of the prior art, until discovery of the present invention, it appears that manufacturers of ice cream scoopers have completely and intentionally ignored combining more complex grapple-type technologies with the practical nature of ice cream scoopers.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view diagram illustrating a general embodiment of an ice cream scooper constructed according to principles of the present invention;

FIG. 2 is a side view diagram illustrating a view of the ice cream scooper of FIG. 1 when in the “open” arrangement, wherein ice cream scooper surface areas are shown that are intended to hold an ice cream scoop that is extracted from an accumulation of ice cream; and

FIG. 3 is a flow diagram illustrative of an embodiment for operating the ice cream scooper of FIG. 1

### DETAILED DESCRIPTION OF THE DRAWINGS

The following is intended to provide a detailed description of examples of the invention and should not be taken to be limiting of the invention itself. Rather, any number of variations may fall within the scope of the invention, which is defined in the claims following the description.

Upon viewing the present disclosure, one of ordinary skill in the art will appreciate that variations to the disclosed system and method could be contemplated.

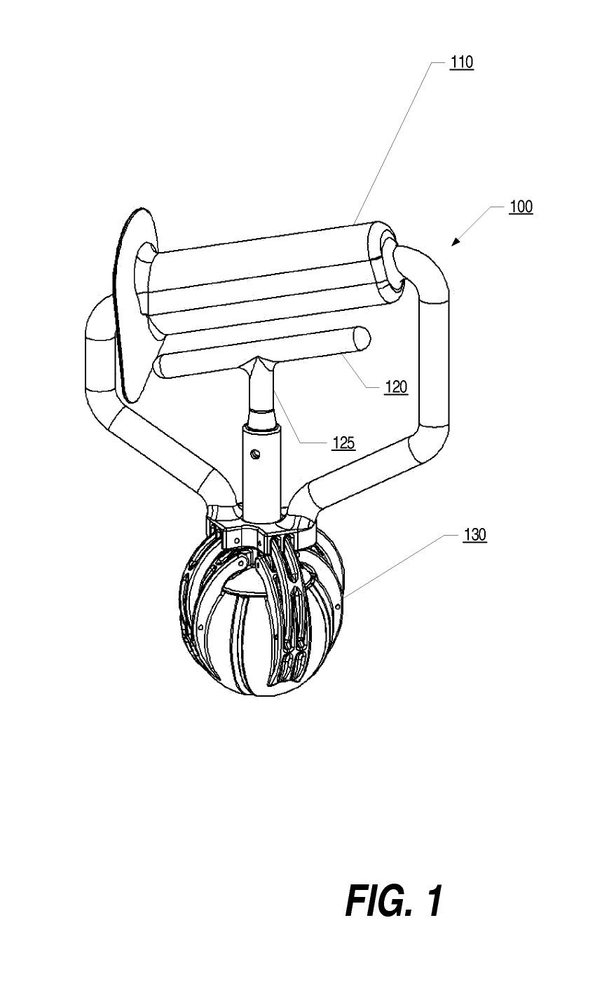

FIG. 1 is a perspective view diagram illustrating a general embodiment of an ice cream scooper 100 constructed according to principles of the present invention. Ice cream scooper 100 includes a handle 110, a grip 120, a mechanical coupling 125, and tines 130 coupled to mechanical coupling 125. The combination of handle 110 and grip 120 are sometimes referred to herein as a retractable handle. In addition, mechanical coupling 125 may be referred to as a mechanical apparatus that is used to change a position of tines 130.

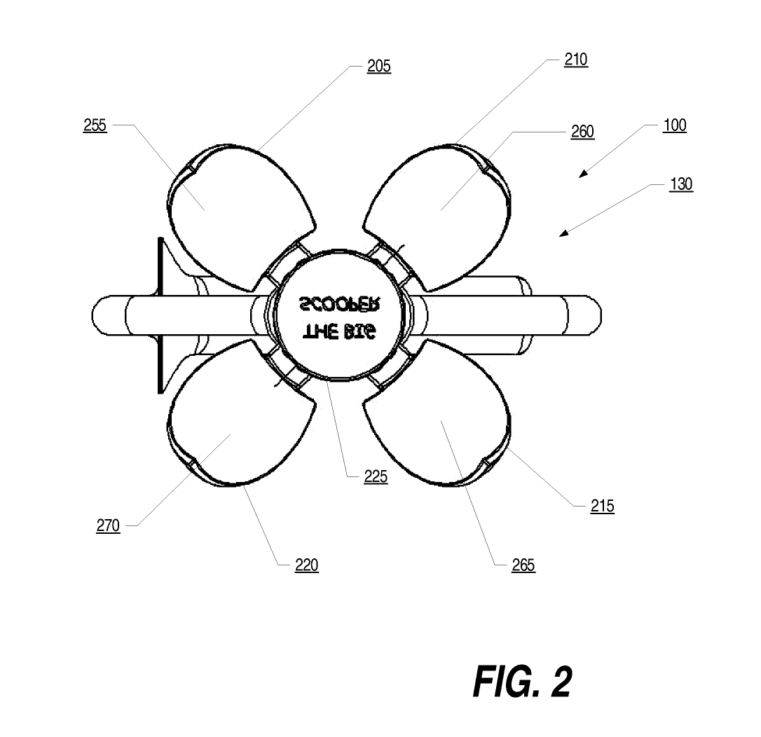

In a preferred embodiment, ice cream scooper 100 is constructed such that grip 120 includes two positions. The first position causes mechanical coupling 125 to place tines 130 in an open arrangement (see FIG. 2). The second position of grip 120 causes mechanical coupling 125 to place tines 130 in a closed arrangement as illustrated in FIG. 1. The closed arrangement is designed to encase a scoop of ice cream from an accumulation of ice cream.

FIG. 2 is a side view diagram illustrating a view of ice cream scooper 100 of FIG. 1 when tines 130 are in an open arrangement. Specifically, in the illustrated embodiment of FIG. 2, tines 130 are shown when mechanical coupling 125 is in the first position and four separate tines 205, 210, 215, 220 are placed in the open arrangement. In addition, a stamp 225 is illustrated in the middle of tines 205, 210, 215, 220 wherein a scoop of ice cream that is gathered within tines 205, 210, 215, 220 would be sculpted or impressed with stamp 225. The impression on the ice cream would become visible after extracting the scoop of ice cream from tines 205, 210, 215, 220 of ice cream scooper 100.

As will be appreciated by those of ordinary skill in the art upon viewing the present disclosure, stamp 225 could be interchangeable with other stamps to accommodate various logos that are to be impressed upon the scoop of ice cream that is created by use of ice cream scooper 100. For example, a commercial ice cream serving enterprise could implement a stamp to indicate a trademark of the enterprise. Further, stamps could be implemented to allow children at events such as a birthday party to choose a personalized logo or figure to appear on their individual ice cream scoop. This personalized ice cream scoop would allow the child to be given a personalized ice cream cone at the birthday party.

Tines 205, 210, 215, 220 each include a respective surface area 255, 260, 265, 270 wherein ice cream may be formed into a smooth scoop or ball. Tines 205, 210, 215, 220 form the scoop by pressing ice cream scooper 100 into an accumulation of ice cream when tines 205, 210, 215, 220 are in the open arrangement. Once ice cream scooper 100 is pressed into the accumulation of ice cream with a downward force, grip 120 is moved from the first position into the second position.

Such grip 120 movement causes mechanical coupling 125 to move tines 130 from the open arrangement into the closed arrangement. In this manner, ice cream scooper 100 forms a spherically shaped ice cream scoop impressed with a stamp. As discussed, in one embodiment, the stamp may be a stamp of choice by the user of ice cream scooper 100.

As will be appreciated by those of ordinary skill in the art when viewing the present invention disclosure, the downward force that is applied to handle 110 and grip 120 of ice cream scooper 100 could be applied with one hand, two hands, or even a mechanical apparatus that is designed to completely eliminate human interaction at all with regard to applying the downward force.

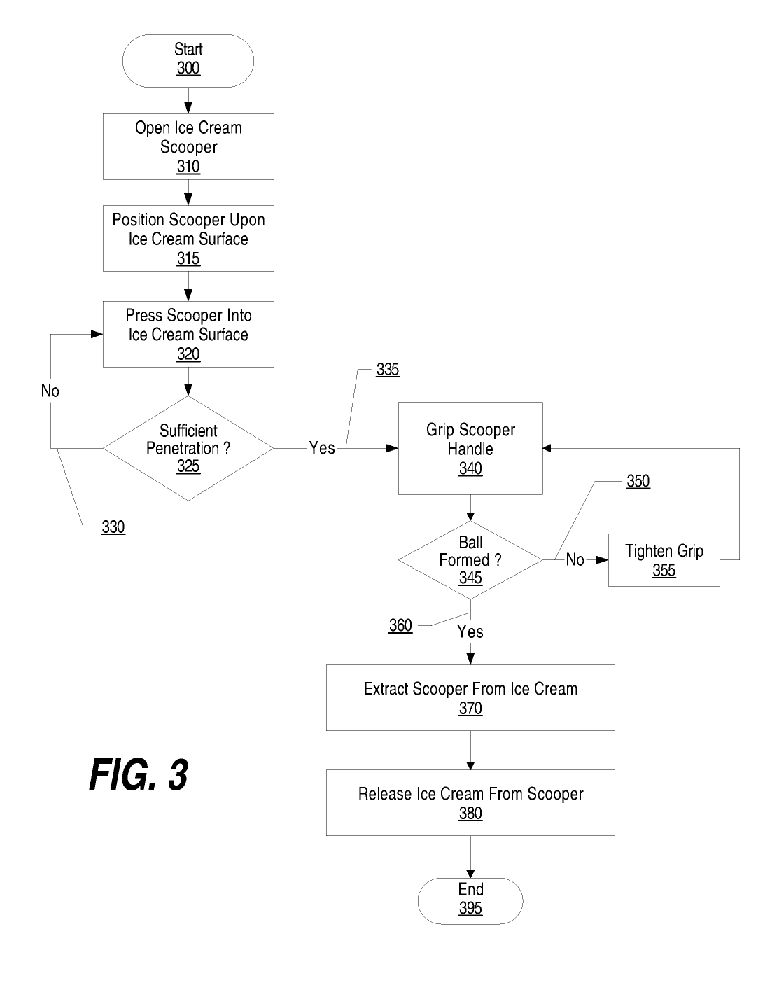

FIG. 3 is a flow diagram illustrative of an embodiment for operating ice cream scooper 100. As illustrated, the method of FIG. 3 begins at start circle 300. At block 310, the method includes opening ice cream scooper 100. Upon opening ice cream scooper 100, at block 315, ice cream scooper 100 is then positioned upon a surface of an accumulation of ice cream. The accumulation of ice cream may be ice cream that is held in an ice cream container, but could also be another type of accumulation such as a conglomeration of ice cream that has been mixed on a refrigerated counter or the like.

As described at block 320, ice cream scooper 100 is positioned upon the accumulation of ice cream such that ice cream scooper 100 may be pressed into the accumulation of ice cream in a manner that tines 205, 210, 215, 220 of ice cream scooper 100 penetrate the accumulation of ice cream. In other words, block 320 discloses ice cream scooper 100 being pressed downward while grip 120 is in the first position.

Diamond 325 illustrates a decision as to whether tines 205, 210, 215, 220 of ice cream scooper 100 have penetrated the accumulation of ice cream sufficiently to form a scoop of ice cream. To form the scoop of ice cream according to principles of the present invention, the scoop of ice cream needs to be adequately large enough to form a sculpted scoop of ice cream. If the scoop of ice cream is adequately large enough to form such a sculpted scoop of ice cream, the sculpted scoop of ice cream is formed when tines 205, 210, 215, 220 of ice cream scooper 100 are moved from the open arrangement of FIG. 2 into the closed arrangement of FIG. 1, and stamp 225 leaves an impression on the ice cream scoop.

As indicated by “no” branch 330 of diamond 325, if tines 205, 210, 215, 220 of ice cream scooper 100 have not sufficiently penetrated the accumulation of ice cream to enable the forming of such a sculpted scoop, ice cream scooper 100 is further pressed into the accumulation of ice cream. On the other hand, as indicated by the “yes” branch 330 of diamond 325, sufficient penetration has been accomplished, and tines 205, 210, 215, 220 of ice cream scooper 100 are moved to form a sculpted scoop of ice cream.

As indicated, sculpted scoop of ice cream is formed by moving tines 205, 210, 215, 220 of ice cream scooper 100 from the open arrangement of FIG. 2 into the closed arrangement of FIG. 1. At block 340, the pressure of grip 120 of ice cream scooper 100 is increased until a ball or scoop of ice cream is formed.

Diamond 345 illustrates a decision as to whether tines 205, 210, 215, 220 of ice cream scooper 100 have formed a ball of ice cream from the accumulation of ice cream. As indicated by the “no” branch 350 of diamond 345, grip 120 of ice cream scooper 100 is tightened at block 355. This process is continued until a ball of ice cream is formed and “yes” branch 360 of diamond 345 is followed. Upon following “yes” branch 360 of diamond 345 the method of FIG. 3 continues.

As described at block 370, ice cream scooper 100 is extracted from the accumulation of ice cream. At block 380, ice cream scooper 100 is opened and a scoop of ice cream is released from ice cream scooper 100. This scoop of ice cream is sculpted with stamp 225 and the flow diagram ends at end circle 395. Of course, this process may be repeated for multiple ice cream scoops of ice cream, or to return a scoop to the accumulation of ice cream and attempt to form a more aesthetically pleasing ice cream scoop.

The included functional descriptive material is information that imparts functionality to an apparatus. This functional descriptive material includes, but is not limited to, mechanical gearing of an apparatus such as ice cream scooper 100 of FIG. 1.

While particular embodiments of the present invention have been shown and described, based upon the teachings herein, it will be appreciated by those skilled in the art that changes and modifications may be made without departing from the principles of this invention and its broader aspects. Therefore, the appended claims are to encompass within their scope all such changes and modifications as are within the true spirit and scope of this invention. Furthermore, it is to be understood that the invention is defined by the appended claims.

It will be understood by those with skill in the art that if a specific number of an introduced claim element is intended, such intent will be explicitly recited in the claim, and in the absence of such recitation no such limitation is present.

For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An ice cream scooper apparatus comprising:
at least four tines being mechanically coupled to a retractable handle, the retractable handle having a first position and a second position, the first position causing the at least four tines to be held in an open arrangement and the second position causing the at least four tines to be held in a closed arrangement;
wherein, each of the at least four tines being shaped such as to enable penetration of an ice cream surface when a downward force is applied to the retractable handle while the retractable handle is in the first position and the at least four tines are set in the open arrangement; and
wherein, after the at least four tines have penetrated the ice cream surface and the retractable handle is placed into the second position, the at least four tines are held in the closed arrangement and the at least four tines enclose a scoop of ice cream.

2. The ice cream scooper apparatus of claim 1 wherein the downward force that is applied to the retractable handle includes at least one human hand for pressing the at least four tines downward into the ice cream surface.

3. The ice cream scooper apparatus of claim 1 wherein the downward force that is applied to the retractable handle includes a mechanical apparatus to press the at least four tines downward into the ice cream surface.

4. The ice cream scooper apparatus of claim 1 wherein the at least four tines further comprise a stamp for impressing a stamp pattern into a scoop of ice cream.

5. The ice cream scooper apparatus of claim 4 wherein the stamp comprises an interchangeable stamp.

6. The ice cream scooper apparatus of claim 1 wherein the at least four tines each include a smooth surface for compacting and shaping a scoop of ice cream from an accumulation of ice cream.

7. A method for scooping ice cream comprising:
applying a downward force to a retractable handle that is mechanically coupled to at least four tines, the retractable handle having a first position and a second position, the first position causing the at least four tines to be held in an open arrangement and the second position causing the at least four tines to be held in a closed arrangement;
penetrating the at least for tines into an ice cream surface while the retractable handle is in the first position and the at least four tines are set in the open arrangement; and
placing the retractable handle into the second position after the at least four tines have penetrated the ice cream surface, the mechanical coupling holding the at least four tines in the closed arrangement and the at least four tines enclosing a scoop of ice cream.

8. The method of claim 7 wherein the method for scooping ice cream is repeated to complete formation of the scoop of ice cream.

9. The method of claim 7 further comprising extracting the at least four tines from the ice cream surface and removing the scoop of ice cream from the at least four tines.

10. An ice cream scooper apparatus comprising:
at least four tines being mechanically coupled to a retractable handle, the retractable handle having a first position and a second position, the first position causing the at least four tines to be held in an open arrangement and the second position causing the at least four tines to be held in a closed arrangement;
wherein, each of the at least four tines being shaped such as to enable penetration of an ice cream surface when a downward force is applied to the retractable handle while the retractable handle is in the first position and the at least four tines are set in the open arrangement;
wherein, after the at least four tines have penetrated the ice cream surface and the retractable handle is placed into the second position, the at least four tines are held in the closed arrangement and the at least four tines enclose a scoop of ice cream;
wherein the at least four tines further comprise a stamp for impressing a stamp pattern into a scoop of ice cream, and the stamp comprises an interchangeable stamp; and
wherein the at least four tines each include a smooth surface for compacting and shaping a scoop of ice cream from an accumulation of ice cream.
